(19) United States
(12) Patent Application Publication
(10) Pub. No.: US 2008/0072220 A1
(43) Pub. Date: Mar. 20, 2008

(54) Sharing Data Processing Resources

(76) Inventors: Fabrice TP. Saffre, Kesgrave (GB); Havard R. Blok, Milton Keynes (GB)

Correspondence Address: NIXON & VANDERHYE, PC, 901 NORTH GLEBE ROAD, 11TH FLOOR, ARLINGTON, VA, 22203, US

(21) Appl. No.: 11/662,340

(22) PCT Filed: Aug. 4, 2005
(86) PCT No.: PCT/GB05/03068

§ 371 Date: Mar. 8, 2007

(30) Foreign Application Priority Data
Sep. 29, 2004 (GB) 0421646.1

(51) Int. Cl. G06F 9/445

(52) U.S. Cl. 717/177

(57) ABSTRACT

A group of computer processing devices are arranged to co-operate to host services for use by each other. Each device stores information relating to the devices known to have such services installed (38). When one of the devices requires a service that it does not already have installed, it transmits a request (32, 35) for the required service. If a neighbouring device is able to provide the service, it responds accordingly (33, 34, 36, 37) and supplies the requested service (391). If a device is unable to identify sufficient suitable neighbouring host devices it may install the service itself (392) when an opportunity to do so is identified.

This application is the US national phase of international application PCT/GB2005/003068 filed 4 Aug. 2005 which designated the U.S. and claims benefit of GB 0421646.1, dated 29 Sep. 2004, the entire content of which is hereby incorporated by reference.

This invention relates to processes for sharing data processing resources.

There is a trend in modern software development in favour of increased modularity and remote access to shared components, so as to be able to rely on so-called “thin clients” running on comparatively less-capable machines as gateways to access sophisticated services. The traditional philosophy tends to assume that a centralised approach would form the basis of the architecture supporting remote access, relying on asymmetrical client-server relationships between subscribers to a service and the provider of that service.

This traditional design philosophy is based on two principal assumptions. Firstly, the cost of “advanced” hardware (for processing, for storage, or for both) was assumed to be such that a substantial economy could be made by limiting over-provisioning. Secondly, it required that end-users would be able and willing to work efficiently with low-end terminal devices. Clearly, these assumptions are complementary, as the willingness of the users to work with more limited terminal devices will depend on how costly the more advanced hardware is to obtain, and how difficult it is to operate and maintain.

However, as the cost of hardware resources tends to fall faster than the need for them increases, the cost of over-provisioning is actually quite low. Moreover, the 100% remote access approach needs very high quality of service (error rates, outage time, etc) and a large bandwidth to be practical. Predictable usage patterns are desirable in order to plan for the distribution of resources.

Many businesses may be willing to manage collaborative software and/or floating licences in a decentralised way to avoid the cost of maintaining a dedicated server infrastructure. Particular problems arise in a decentralised environment when services are to be accessible via portable devices, which result in a highly dynamic changes in connectivity.

An architecture can be envisaged in which individual users only rely on remote access for services that are not considered critical. However, this would limit the individual end users' freedom to decide which are their most important needs and act accordingly. Alternatively, if the individual users are allowed to decide for themselves which services are critical, some duplication would be required as all services would nevertheless have to be available centrally for those users who do not so decide. Furthermore, such an arrangement would result in an architecture in which service availability would be vulnerable to the loss of a small number of core machines.

Consequently there is a tendency for each individual user to have resources available that, for most of the time, are under-utilised. It would be advantageous to improve the utilisation of these resources when the opportunity arises, whilst avoiding dependence on their availability.

The development of so-called “grid” computing allows “idle” processing power to be re-allocated for long-lasting, computationally intensive jobs. Haas, R. et. al. (Autonomic service deployment in networks. IBM Systems Journal, Vol. 42, No. 1, 2003) propose a mechanism for autonomic deployment of services in configurable or programmable networks based on requests by end clients. This approach uses a hierarchical network where routers, gateways, tunnels, transcoders etc. provide end-to-end applications with specific services: the edge nodes themselves are not affected. However, this is primarily suitable for systems in which the availability of terminals and their connectivity and capabilities is predetermined, allowing the available processing power to be used as required. Such an arrangement is less appropriate in a ubiquitous (pervasive) context involving mobile devices, with its additional constraints such as spatial localisation, movement, wireless links require ad hoc arrangements to be made based on the current availability and connectivity of the individual devices.

Data may also be distributed amongst a number of users, such that an individual user may need to obtain data from some other user.

Mikic-Rakic, M. and Medvidovic, N. (Support for Disconnected Operation via Architectural Self-Reconfiguration. Preceedings of ICAC 2004, May 2004, New York) demonstrate how software components may be distributed to devices with limited resources in a mobile environment. In particular they focus on how monitoring, estimating and redeploying components in an autonomous fashion increases the availability of the system as a whole. Individual devices report back to a server which handles estimation of redeployment of services, allowing devices to share components with neighbouring devices and therefore provide the necessary services to each other. The server uses a number of algorithms which try to solve the scheduling of software components hosted on hardware hosts. This process requires a supervisory function, carried out by a server, which makes it unsuited to networks subject to dynamic changes in the requirements and availibility of individual users.

According to the invention, there is provided a computer processing device having the capability to access services installed on co-operating devices, and the capability to retrieve data to allow installation of such services for its own use and for the use of co-operating devices, comprising means for identifying the current extent of provision of one or more services, further comprising means identifying whether an underprovision condition exists for a service required by the device and means for retrieving data for installing, on the device, one or more services for which such an underprovision condition is identified, and means to allow access by co-operating devices to the services stored thereon in response to a request from such a co-operating device.

According to another aspect, there is provided a method in which computer processing devices co-operate to host services for use by each other, wherein the devices co-operate to identify the extent of provision of a given service, in which a first device, when requiring a service that it does not already have installed, attempts to identify a neighbouring device which can provide the required service, and if it identifies an underprovision condition, it attempts to install the required service by retrieving service data suitable for performing the service.

The service to be accessed may be a database, or a program designed to manipulate data.

The device may host the service itself, but otherwise the availability of a service to any given device depends on there being a neighbouring device capable of providing the service to it. This capability depends on whether the neighbouring device hosts the service. However, although the requesting device may have information that indicates that one of its neighbours hosts the service, that neighbour may currently be unable to provide the service. It may be already fully occupied providing the service to other devices, or it may be unable to communicate efficiently with the requesting device. Effective communication depends on the devices both being currently connected to network connections having a bandwidth appropriate for the task. Other factors, such as the number of intermediate links, may also affect the efficiency of a connection. Such conditions will change over time, both because of fluctuation in demand for different services, but also because of changes in the connectivity of the network as mobile devices move around the network. Incentives may be made to encourage users to keep their devices on-line when they are not using them, so that the capacity can be used by others. However, from time to time individual devices, whether mobile or not, may nevertheless go off-line for a number of reasons, such as power or communications failure, or a need to operate in a secure mode. Whilst it is off-line, any service hosted by the device is unavailable.

An individual device may identify an underprovision condition by predetermined absolute criteria such as the number of devices it identifies as currently hosting the service. However, it is preferred to use a dynamic criterion such as failure of the device to identify a host capable of providing a service when it requires to use it. This may be done by broadcasting a request to all devices within range. However, if any neighbouring devices are already recorded by the subject device as hosting the service, a specific request may first be targetted to those devices. If the target devices are for some reason unable to fulfil the request (perhaps because they are already fully occupied hosting the service for other parties, or are not currently within range), a broadcast request can then be made. Requests may be forwarded from one device to another, so that devices not in direct contact with each other may provide services to each other, using intermediate devices as relays. As relaying in this way affects transmission quality (especially delays), and it requires the use of resources in the relaying devices, it is desirable to limit the number of steps that may be used. In the embodiment to be described, the number of steps is limited to two—that is to say, only one intermediate device may be used as a relay.

If no suitable host is identified, the program data required to operate a given service may be accessed from a central database, or from another device already hosting the service, should one be available. The user may instead elect not to use the service at that time, but to make another attempt later. Underprovision may be defined in terms of the number or proportion of unsuccessful attempts made to access the data. A stochastic process may be used, in which a tuneable random element is applied to the identification of an underprovision condition., therefore making the choice of installing (or uninstalling) a probabilistic one. Different users may select different thresholds for this definition. By exploiting the random fluctuations occurring in the population of devices behaving in this way, the availability can be progressively and dynamically adjusted to the demand.

In the event that the device does not have the data storage capability to host the service, it may delete a service for which an overprovision condition is identified, using similar criteria.

The data module needed to run the additional service need not be downloaded immediately, if the facilities to do so are not available. For example, a user may instead resort to using a fixed terminal, or postpone the desired operation until such time as the service data can be downloaded. When an opportunity to download arises (e.g. when a mobile device is directly wired into the Net or wirelessly connected to a base station that is itself so connected), the device (or the user) makes a decision about whether or not to install it, depending on the absolute number of failed attempts, the capacity of the device, and stored information describing past experience, to select the module to be installed.

The system self-organises over a variable period of time, possibly several days if the devices have direct network access only once a day. For example a mobile device may have an associated cradle providing an internet connection and battery recharge function, into which the mobile device is placed when the user is not using it. Initially, no devices in the system would support ubiquitous access, so users would need to download any program data they require. However, as well as retrieving the data, they store it on their mobile devices. This allows the user to operate the process without recourse to a fixed terminal the next time the program data is required. Furthermore, should another user be within range and need the same information, the first device can answer the request, saving the other user from having to download the program data from a fixed terminal. Over time the more commonly used services would become “pervasively” available, and only unusual requests would go unanswered and require the user to go to a fixed terminal.

The invention therefore combines an interaction protocol with local decision rules to allow the peer to peer (P2P) community to take advantage of a process of differentiation between devices in order to achieve acceptable quality of service whilst limiting over-provisioning, by detecting opportunities for co-operation in cases of resource under-utilisation. By trial and error, individual devices identify and specialise in hosting an appropriate sub-set of all the services they need. Other services that they require do not form part of this subset because they are hosted on other members of the community. The result is a community that self-organises as a whole, adjusting offer to demand and taking into account implicit constraints in an unpredictable and dynamic environment.

The present invention therefore allows improved utilisation of available resources when the opportunity arises, whilst avoiding being dependent and without restricting the user's ability to choose which services to host, and without the need for the user to have explicit, quantitative knowledge of availability. The identification of an “underprovision” situation is made by trial-and-error, which allows the system to achieve adequate service coverage and load-balancing in the absence of any explicit information about patterns of activity (including physical movements in the wireless case). Since the decision-making is fully decentralised, the criterion for identifying insufficient availability is an individual one. For example users may decide that a service module should be downloaded if availability of the corresponding service falls below a given threshold, which may vary from one user to another, for example depending on the frequency or urgency with which that service is required by the individual user. Thus individual users would tend to install modules that they personally consider to be critical, possibly reducing the perceived cost of joining the community.

For such a system to operate effectively, a regulatory, economic, contractual or other framework needs to be in place to require or persuade the individual members of the scheme to consistently make services available whenever they can. Whilst such considerations are of a non-technical nature and will not be discussed in detail, the invention may advantageously include a supervisory function to monitor individual participants for the use they make of services provided according to the invention, and the provision they themselves make of such services for the use of others.

An illustrative embodiment of the invention will now be described, by way of example, with reference to the drawings, in which:

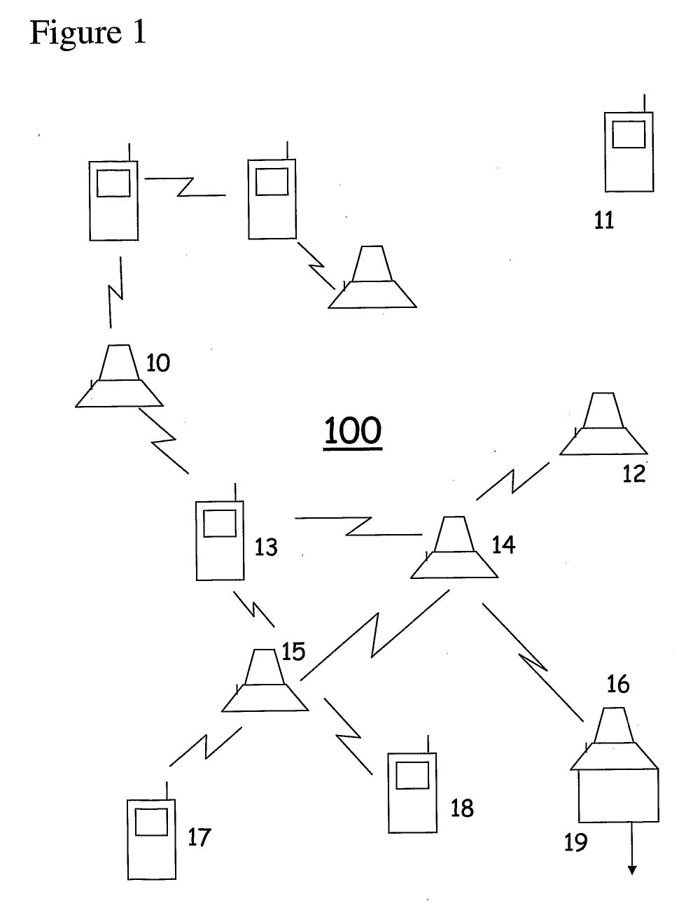

FIG. 1 is a schematic representation of an interconnected group of data processing devices

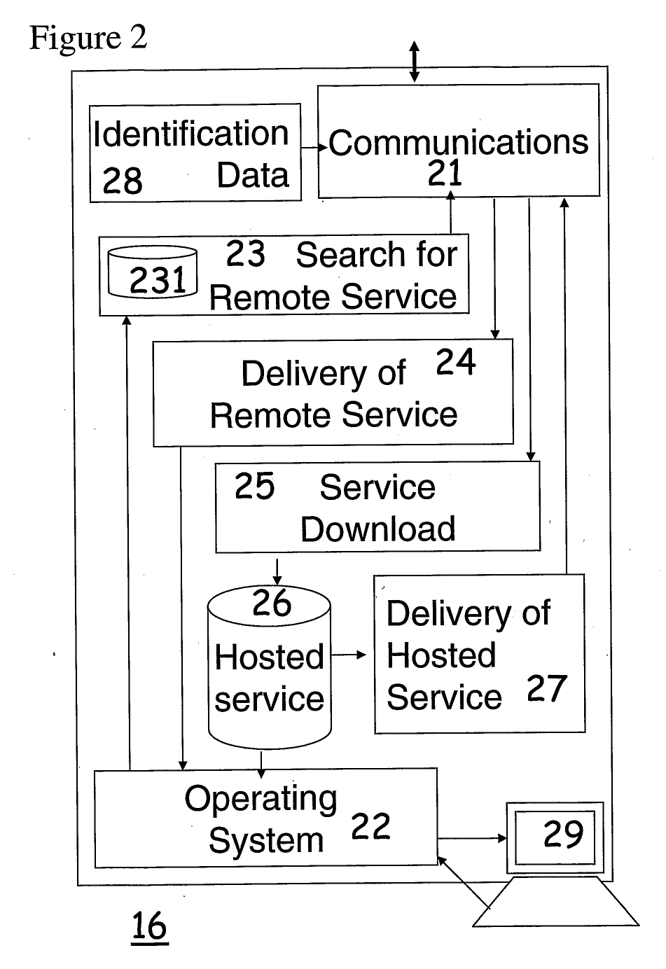

FIG. 2 is a schematic representation of the functional elements of an individual data processing device

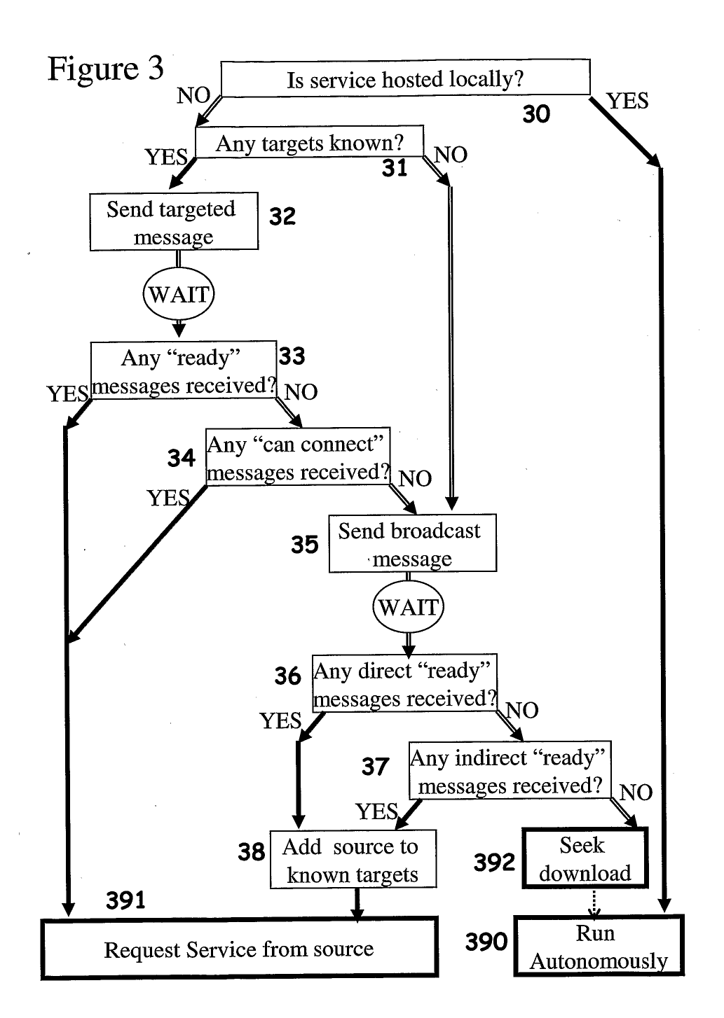

FIG. 3 is a flow diagram illustrating the operation of an embodiment of the invention requesting service from another device

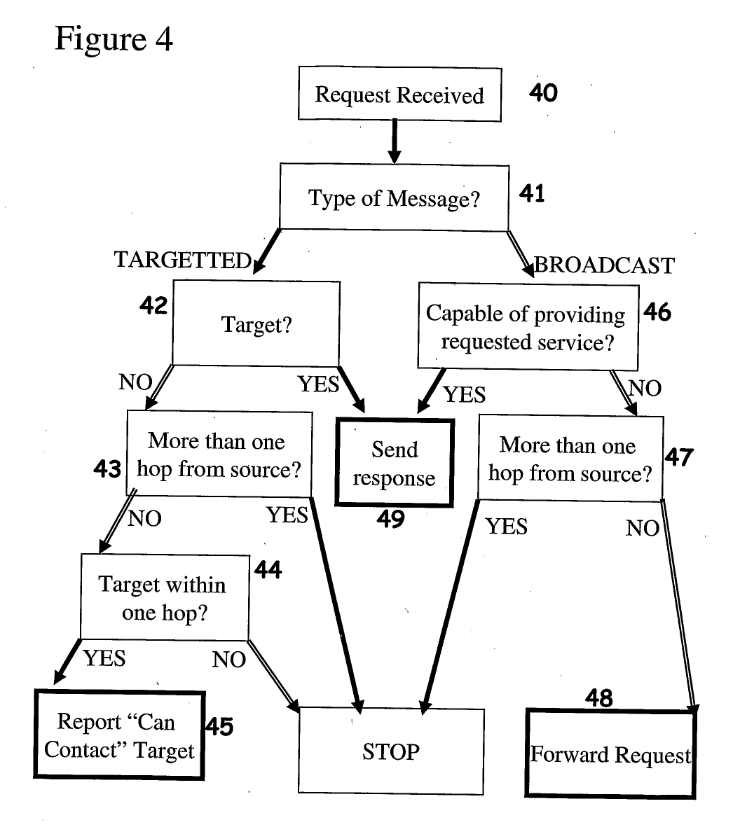

FIG. 4 is a flow diagram illustrating the operation of an embodiment of the invention receiving a request for service from another device, and

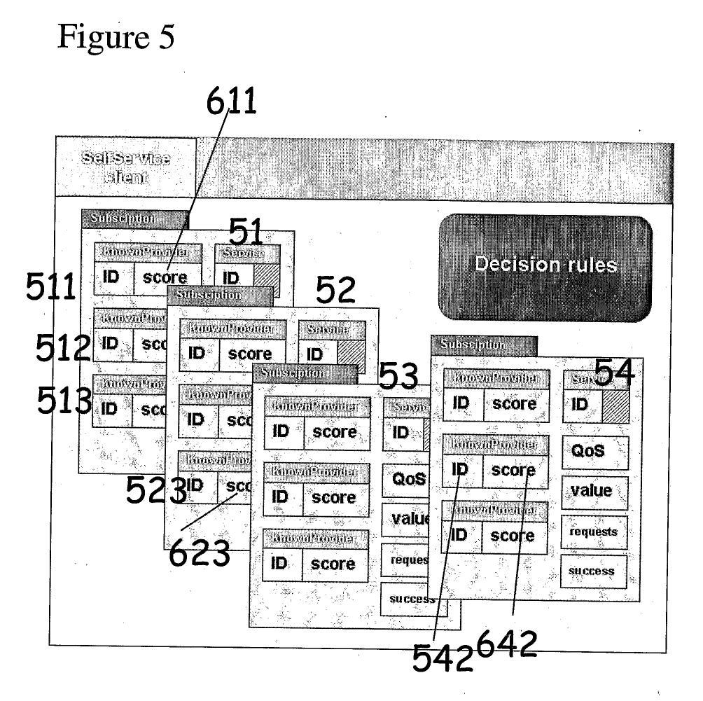

FIG. 5 is a diagrammatic representation of a data record held in the data store 231 of FIG. 2

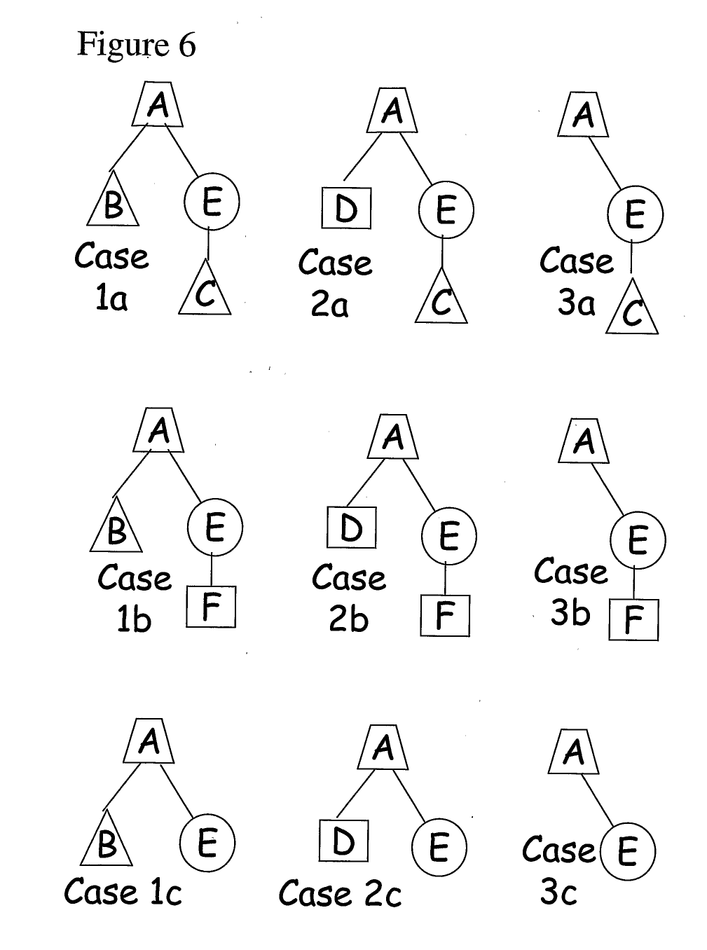

FIG. 6 is a diagrammatic representation of nine scenarios, illustrating worked examples of the invention in use.

FIG. 1 is a schematic representation of a network 100 of mobile computing devices (not all individually referenced), between which there exists a communication medium, allowing any individual unit (e.g. 14) to exchange information with any other unit within range (e.g. 12, 13, 15, 16). Each unit 14 may communicate with more remote units (e.g. 10, 17, 18), using nearer units (13, 15) as relays. (For present purposes, two “hops” (i.e. a single relay) is assumed to be the maximum permitted, but more hops may be used in practice). Communication may use any suitable medium, such as wireless (radio, infra-red, etc) data transport.

Each device also hosts a subset of the total set of services that the devices may require to use. (Individual units may from time to time host all or none of these services). These services may include both data and programs to allow data to be manipulated. Every member device carries a unique identification code which it periodically advertises using an identification function 28 (see FIG. 2) so as to ensure that every unit 14 is aware of its first neighbours 12, 13, 15, 16. In practice, as shown for device 11, an individual device may be added or removed from the group 100 as it and its neighbours move around, or are switched on or off, and this will also affect the supply and demand of the services. Even if the connections between the devices, and their network presences, are invariant over time (as would be the case for fixed devices if they were always connected), there would be changes in the availability of, and demand for, the various services they host.

As shown for device 16, an individual device may from time to time be docked with a connection 19, allowing access to a store of services.

FIG. 2 illustrates in detail one of the data processing devices 16 shown in FIG. 1. It comprises a communications interface 21 for establishing and maintaining communication with other devices, (such as neighbouring mobile device 14 and fixed docking station 19), an operating system 22, a service search function 23 including data storage means 231 for storing data relating to the services available from other similar devices, service access means 24 for co-operating with a service host, a service download function 25, storage means 26 for storing the services the device is itself hosting, service delivery means 27 for delivering such hosted services to remote terminals requesting such services, and the identification function 28 already discussed. Most such devices would also incorporate a user interface 29, although the scope of the invention does not preclude the provision in a network of devices dedicated solely to hosting services for the use of other neighbouring user devices.

In the following description, where it is necessary to distinguish between the components of a first device according to FIG. 2 requesting service, and a second, similar, device providing that service, the elements of the latter will be identified by a “prime”. Thus a service stored on the service storage means 26′ of a host device is delivered to an operating system 22 on a receiving device by means of a service delivery function 27′ of the host device and a service access function 24 on the client device, by way of respective communications functions 21′, 21.

The process shown in FIG. 3 provides for the distribution of pervasive services in an ad-hoc, P2P environment. The process is one of self-organising differentiation, in which the individual members of a community of similar units acquire different capabilities that make them each capable of performing a sub-set of all the functions necessary for the community to operate as a whole. This specialisation is made at the expense of the unit's ability to perform other tasks, which are then taken care of by other units who have selected a different speciality, in a process leading to mutual dependency and co-operation. This is achieved without central control, via a number of positive and negative feedbacks between the individual members.

The signal triggering the specialisation of an individual unit into a given task is the shortage or accumulation of a capability, the availability of which is measurable by the candidate units. In this embodiment, an accumulation of failed requests for service, denoting the poor availability of a service to the member of the resource-sharing community making the requests, is likely to initiate a course of action susceptible to resolve that situation. Combined with random space-time fluctuations and a gradual, at least partly reversible transformation process, this provides the basis for coordinated specialisation of the right number of units into each necessary function. This process will now be described in more detail.

At the time of joining a community of resource-sharing peers operating this process, the new member would select a number of services from a list of available options. The newcomer also attributes a value v (0<v≦1) to every chosen service, which is used exclusively for evaluating perceived local quality of service, and make decisions about whether or not to install new components. Finally, to “bootstrap” the collaborative process, the new member installs the necessary software components to host at least one service from its chosen selection. This software is downloaded from a source database, which may be one of the peer devices or a special dedicated database.

When in need of a service, a device will be in one of three possible situations, as shown in FIG. 3. It may already have all necessary software components installed (outcome 390), or it may be able to identify a neighbouring device that has them and can host the service (outcome 391). The third situation is the condition that neither the subject device nor any of its neighbours have the software installed (outcome 392). The device therefore needs to test which of these conditions applies, according to the process shown in FIG. 3. It first checks whether all necessary components are locally installed (step 30). If this is the case, it can act as its own provider and the operating system 22 can run the service autonomously (step 390).

If it does not already host the service, the search function 23 attempts to identify a partner device that can host the required service. This it does by generating a request for the service to be hosted on a neighbour device. In this embodiment, it first checks in the data store 231 for any devices already known to host the service (step 31), and the request is targetted on those devices (step 32): otherwise it broadcasts a request to all neighbouring devices (step 35).

A targeted request is a request that includes a reference to the needed service and a list of one or more intended recipients. A broadcast request is not specifically targetted. The originating device sends the request to all its neighbouring devices, but a device receiving such a request (steps 40, 41) ignores any targetted request unless the recipient's list contains the ID of the receiving device (step 42) or the ID of one of its own first neighbours (step 44).

Several outcomes may be considered:

If the requesting device can provide the IDs of one or more known providers for the required service (step 31) it transmits a targetted request with those IDs (step 32). If at least one of those known providers is a first neighbour, the targeted request will necessarily reach a suitable provider (step 40, 41, 42). That device will respond to the request by offering to host the requested service (step 49), retrieving the necessary program data from its store 26′ and delivering the service using the service delivery function 27′. However, if none of the known providers is among the requester's first neighbours, there is still a possibility that one of the first neighbours itself has one of the target devices as its own neighbour. If such a “second hop” neighbour is identified as a target device (steps 43, 44), the first neighbour reports this information back to the requesting device (step 45), and prepares to act as a relay between the requesting and targetted devices.

The requesting device awaits “ready” responses (49) to its targetted request. If it receives such a response (step 33), it then requests service from the device making the offer (step 391), which is delivered to the client functionality 24 to control the operating system 22. In the event that it receives more than one such offer, it selects one of them on a random basis, or according to some criterion such as the quality of the communications link between them. If no “ready” responses are received, it checks for indirect responses (45). If it receives such a response (step 34), it then requests service from the device identified (step 391), using the intermediate device as a relay.

If this process fails to identify a suitable host, either because the requesting device fails to provide the IDs of any known hosts (step 31), or because the targetted mesaage fails to locate any of them (step 33, 34), a broadcast request is made (step 35). A broadcast request is a request that includes a reference to the needed service, but no list of intended recipients (so as to allow every device receiving it and capable of providing the service to respond). The broadcast message is passed along existing connections according to a predefined set of rules. In particular, the number of times a broadcast request may be forwarded may be limited so that it will only propagate a predetermined number of steps away from the requesting device—in this example a maximum of two steps. This allows the amount of traffic generated to be limited—moreover quality of service of the resulting service would be expected to be lower if the link between client and hosts had to pass through several intermediates). As a result, the main difference between targeted and broadcast requests is the way they are interpreted and processed by peers who receive them, not their range.

If a device receives a broadcast message, a receiving device checks whether it can itself provide the requested service (step 46). If it can, it transmits a response to the requesting device (step 49). If it cannot, and it is less than the maximum number of steps for the originating device (check step 47), it forwards the request to any other devices to which it is directly connected (except the one it received it from) (step 48). Those devices respond in the same way.

If the originating device receives a response to a broadcast message (step 36, 37), it requests the device to host the requested service for it (step 391). Again, if more than one device responds, one of them is selected. Those requiring the fewest hops are likely to be the most reliable, and they can be preferentially selected by being checked for first (step 36) before those requiring more hops (step 37).

The probability of a request (targetted or broadcast) reaching a given addressee depends on the respective location of the requester and provider. The table below lists the possible outcomes if propagation does not continue beyond first neighbours. It will be seen that the targeted requests allow the selection of providers already known to the device, where such exist, and that if the targeted request fails to achieve an outcome, the broadcast request will then identify any other suitable provider within the two-hop range. In both cases, a device at a single hop is selected in preference to one at two hops, but note that a known device at two hops is selected in preference to an unknown one at one hop.

| | | Service providers at one hop | | |
|---|---|---|---|---|
| | OUTCOME | 1: Known | 2: Unknown | 3: None |
| Service | a: Known | Use known | Use known provider at two hops | |
| Providers | b: unknown | provider | Use new | Use new provider |
| at two | | at 1 hop | service | at two hops |
| hops | | | provider | (update record) |
| | c: None | | at one hop | Unsuccessful - |
| | | | (update | try to download |
| | | | record) | |

Examples of each case will be discussed with reference to FIG. 6. In each of these examples, a device A requires a service x, and devices B, C, D and F all host the service x. Device A is aware that devices B and C can host the service, but is not aware that devices D and F are also capable of doing so. Device E does not host the service. With the exception of the connection between devices A and E, which is common to all the examples, connectivity varies between cases. Unless stated, each device is more than one hop away from both device A and device E.

In the cases 1a, 1b, 1c, devices B and E are within one hop of A. In cases 2a, 2b, 2c, devices D and E are within one hop of device A. In Cases 3a, 3b, and 3c only device E is in communication with device A.

Furthermore, in the cases 1a, 2a, 3a, device C is within one hop of device E, whilst in the cases 1b, 2b, 3b, device F is within one hop of device E, and in the cases 1c, 2c, 3c, neither device C nor device F is within one hop of device E.

In each case, device A follows the procedure illustrated in FIG. 3, and any other device receiving a request from device A responds according to the process of FIG. 4. Initially, Device A identifies that it does not itself already host the required service (step 30) and identifies (step 31) that it is aware of some other devices that do host the service. (B and C). It therefore sends a message to its current neighbour devices, addressed to the known hosts (step 32), and awaits a response. The neighbour devices receive these requests (step 40) and identify them as targetted (step 41). From this point the outcomes vary between the individual cases.

Case 1a

| | |
|---|---|
| B and E are within one hop of A | A to B and C: “I need service x . . . ” |
| C is within one hop of E | B to A: “Ready” |
| | E to A: “Can contact C” |
| | A to B: “Request service x . . . ” |

Case 1b

| | |
|---|---|
| B and E are within one hop of A | A to B and C: “I need service x . . . ” |
| F is within one hop of E | B to A: “Ready” |
| | A to B “Request service x . . . ” |

Case 1c

| | |
|---|---|
| B and E are within one hop of A | A to B and C: “I need service x . . . ” |
| | B to A: “Ready” |
| | A to B: “Request service x . . . ” |

In these three cases, device B receives a targetted request directly from device A. As it is itself one of the targets (step 42) it transmits a response (step 49). On receiving this response (step 33), Device A requests service (step 391). Device E also receives the targetted request. It is not itself a target (step 42), so it checks whether it is within one hop both from the source of the request (step 43) and from any target device (step 44). In Case 1a it finds target Device C, and reports this back to Device A. (step 45). However, Device A does not act on this information as it has already identified a closer target.

Case 2a

| | |
|---|---|
| D and E are within one hop of A | A to B and C: “I need service x . . . ” |
| C is within one hop of E | E to A: “Can contact C” |
| | A to C (via E): “Request service x . . . ” |

Case 3a

| | |
|---|---|
| E is within one hop of A | A to B and C: “I need service x . . . ” |
| C is within one hop of E | E to A: “Can contact C” |
| | A to C (via E): “Request service x . . . ” |

In these two cases there is no target device (B, C) within one hop of Device A. Note that in Case 2a, this is despite Device D being capable of providing the service, since Device A is initially unaware of this. As in Case 1a, Device E is within one hop of targetted Device C, and therefore reports this back to Device A. Device A, having received no direct “ready” messages (step 33) responds to the “can connect” message from device E (step 34) by requesting service from Device C, relayed through Device E.

Case 2b

| | |
|---|---|
| D and E are within one hop of A | A to B and C: “I need service x . . . ” |
| F is within one hop of E | No answer |
| | A to all: “I need service x . . . ” |
| | E to all: “A needs service x . . . ” |
| | D to A: “I host service x . . . ” |
| | F to A (via E): “I host service x . . . ” |
| | A to D: “Request service x . . . ” |

Case 2c

| | |
|---|---|
| D and E are within one hop of A | A to B and C: “I need service x . . . ” |
| | No answer |
| | A to all: “I need service x . . . ” |
| | E to all: “A needs service x . . . ” |
| | D to A: “I host service x . . . ” |
| | A to D: “Request service x . . . ” |

In these two cases, there are no responses to the targetted request (steps 33, 34) so Device A transmits a broadcast request (step 35). In both cases, Device D receives the broadcast request and responds to it (step 46). This response is received by Device A (step 36) which adds device D to the list of service providers and requests service from Device D. Device E also receives the request, and being unable to service the request itself forwards it (steps 47, 48). In case 2b, the forwarded request is received by Device F which transmits a response (steps 46, 49) back via Device E, but Device A disregards this indirect response as it has already received a direct response.

Case 3b

| | |
|---|---|
| E is within one hop of A | A to B and C: “I need service x . . . ” |
| F is within one hop of E | No answer |
| | A to all: “I need service x . . . ” |
| | E to all: “A needs service x . . . ” |
| | F to A (via E): “I host service x . . . ” |
| | A to F (via E): “Request service x . . . ” |

As for Case 2b, the targetted message fails to reach either of the addressees B or C (steps 33, 34) so Device A transmits a broadcast request. In this case no device capable of providing service receives the broadcast request directly, so no direct response is received by Device A (step 36). Device E receives the request, but being unable to service the request itself forwards it (steps 47, 48). The forwarded request is received by Device F which transmits a response (steps 46, 49) back via Device E. Device A responds to this indirect response (step 37) by adding Device F to the list of service providers and requesting service from Device F.

Case 3c

| | |
|---|---|
| E is within one hop of A | A to B and C: “I need service x . . . ” |
| | No answer |
| | A to all: “I need service x . . . ” |
| | E to all: “A needs service x . . . ” |
| | No answer |

In this case, Device A receives no response to either the targetted message (step 32) or the broadcast message (step 35), so it is not possible to request service from any potential host (step 391) and some alternative method of operation must be sought (step 392).

When a requester receives an answer to a broadcast request from a previously unknown provider, either directly (step 36) or via a common first neighbour (step 37), it stores that provider's ID in a list of known providers for this service (step 38) for use in future targeted requests and decisions. The data stored is represented in FIG. 5. For each service a list 51, 52, 53, 54 of known providers (511, 512, 513 etc) is maintained. Each provider 511 has a corresponding “score” 611 etc associated with it. If adding the new unique ID would result in the list exceeding its maximum length, it replaces the last entry instead (the order in which IDs are stored indirectly reflects the relative availability of all known providers, see below). If several replies are received to one request, one of the replying devices is chosen at random. Note that more than one ID may be stored (step 38) before one of them is selected (step 391).

Every time that a known provider 511 etc answers a request, its “score” 611 is incremented by a value which can integrate a number of relationship-specific variables (trust, service charge, delay . . . ). Although there can only be one reference 511 to a given provider per subscription 51, the same device can be a known provider for several services 52, 53, in which case it will have a separate entry 523, 542 in each corresponding subscription). This also means that the same device can have different scores 623, 642 for different services that it is (or has been) providing to one other member, or different scores for the same service if it is (or has been) acting as a provider to several other peers. Basically, the “score” refers to one relationship between two members for one service and is owned/maintained by the individual user.

The score is periodically used to rank providers, independently for every subscription 51, 52, 53. The result is that the best performing provider over the chosen period appears first in the list, and the worst appears last. Since it is the last entry that is replaced by the unique ID of a newly identified provider following a broadcast request (see above), the system tends to select the best (i.e. most frequently available) candidates over time, by “forgetting” poor performers (i.e. peers that were once “tried” as providers but are actually not spending long periods within reach of the requester and so are not suitable for long-term association). An alternative solution would be to store the addresses of all identified providers for a service over the selected period, rank all of them, then “dump” the excess. From a logical point of view, the two approaches are very similar, but the former has the advantage of requiring less storage and processing, while the latter is likely to increase efficiency.

Whenever a request is made, it can either be replied to “immediately” (either by a known target provider or by some other peer after a broadcast), or not. In the second case, it is added to a list of “pending” requests, and will be “re-examined” (i.e. re-sent) periodically until either a provider becomes available, or it has reached a pre-selected “time-to-live” (TTL) limit. In the second case, it is said to have “failed” (i.e. it is discarded and the “success” variable for this subscription is not incremented.

The adjustment of the offer to the demand is realised via local installation of new software modules by individual community members. The decision whether to install a new module or not is made by a peer every time a request for the corresponding service has failed. Depending on the balance between the value that it attributes to the service and its perceived availability (proportional to the success/requests ratio), the device can choose not to rely on remote access any more, but can take the necessary steps to contact a central repository and download/install the module to its own program data store 26 using the download function 25.

Should a suitable partner be identified by this process, (step 33, 36, 37) the requesting device runs the program (391) using the partner as a host. If no potential suitable partner hosts the service, or any device that does so is already serving some other partner or is incompatible for some other reason such as insufficient communications bandwidth, the connection fails. The device may then access a source provider of the program data and install the required software components itself, either immediately or when the data becomes available (step 392). It can then run the program itself (step 390) without needing remote access. (Note that the downloading of a program for use locally requires less bandwidth than remote hosting of the program).

Now that the program data has been downloaded, this device can subsequently act as a provider (host) for other devices requiring this program. (It will give a positive response (46) to any broadcast requests it receives (41) for this service, and in time will be identified by other users (step 38) and also become the subject of targetted requests). Thus, the initial corrective action, primarily aimed at solving a problem for the individual device, will effectively increase availability of the incriminated service and contribute to improve the overall availability, reducing the need for other peer devices to install the corresponding program data module.

There is assumed to be a cost of hosting the procedure (otherwise there would be no advantage in sharing modules or using remote access, and the optimal solution would be for every user to install all components locally). This cost can be either financial (e.g. if the software manufacturer charges more for installing the module than for accessing the corresponding service from another peer) or, more likely, involve some sort of inconvenience (e.g. long download time, waste of storage capacity, or necessity to find a fixed network access point). In order to simulate the “reluctance” of a community member to go through the installation process, a random test is conducted against a fixed threshold every time that the option is being considered. Depending on the value chosen for that threshold, this typically results in several failed requests being needed before the procedure is actually initiated. It is important to understand that the reason for such failure is not taken into account, which means that the invention can in principle be used to manage any system where availability is variable and/or unpredictable, independently of the cause of this situation. In the simulated ubiquitous service environment, it is the result of the physical movement of the participating devices, which move into and out of range of each other, but in other scenarios it could be a shortage of resources on otherwise suitable providers (e.g. processing power in GRID computing).

The invention is intrinsically robust to perturbations, as the “trial and error” nature of the decision process allows it to spontaneously react to changes in the balance between offer and demand. New peers install “missing” modules when they detect that availability has become unsatisfactory for their own needs, restoring overall service quality levels in the process.

1. A computer processing device having the capability to access services installed on co-operating devices, and the capability to retrieve data to allow installation of such services for its own use and for the use of co-operating devices, comprising means for identifying the current extent of provision of one or more services, further comprising means identifying whether an underprovision condition exists for a service required by the device and means for retrieving data for installing, on the device, one or more services for which such an underprovision condition is identified, and means to allow access by co-operating devices to the services stored thereon in response to a request from such a co-operating device.

2. A device according to claim 1, comprising decision means to determine whether a service should be installed when an opportunity to download it arises.

3. A computer processing device according to claim 2, further comprising means for deleting a service for which an overprovision condition is identified to allow a further service to be installed.

4. A device according to claim 1, comprising means to attempt to identify a neighbouring device capable of providing it with a required service, wherein an underprovision condition is defined by failure to identify such a device.

5. A device according to claim 4, where the underprovision condition is defined as a predetermined number of failures to identify such a device.

6. A device according to claim 5, wherein the predetermined number of failures is defined as a proportion of attempts made over a predetermined time.

7. A device according to claim 4, further comprising means for applying a tuneable random element to the identification of an overprovision or underprovision condition.

8. A device according to claim 1, comprising means for storing information relating to devices hosting the required service, and means for transmitting a request for the required service, addressed to the devices so identified.

9. A device according to claim 1, comprising means for broadcasting a request for service to all devices within range.

10. A device according to claim 8, comprising means to forward any such requests that are received from other devices a predetermined number of steps.

11. A method in which computer processing devices co-operate to host services for use by each other, wherein the devices co-operate to identify the extent of provision of a given service, in which a first device, when requiring a service that it does not already have installed, attempts to identify a neighbouring device which can provide the required service, and if it identifies an underprovision condition, it attempts to install the required service by retrieving service data suitable for performing the service.

12. A method according to claim 11, wherein information relating to underprovision conditions is stored and a device installs such services when an opportunity to do so is identified.

13. A method according to claim 11 wherein an underprovision condition is identified by failure to identify a neighbouring device capable of providing the required service to the first device.

14. A method according to claim 13, where the underprovision condition is identified as a predetermined number of failures to identify such a device.

15. A method according to claim 14, wherein the predetermined number of failures is defined as a proportion of attempts made over a predetermined time.

16. A method according to claim 13, wherein a tuneable random element is applied to the identification of an overprovision or underprovision condition.

17. A method according to claim 11, wherein each device stores information relating to devices it has identified to be hosting the required service, and transmits a request for the required service, addressed to the devices so identified.

18. A method according to claim 11, wherein the device broadcasts a request for service to all devices within range.

19. A method according to claim 17, wherein such requests are forwarded from one device to another over a predetermined number of steps.

20. A method according to claim 11, further comprising a supervisory function to monitor individual participants for the use they make of services provided according to the invention, and the provision they themselves make of such services for the use of others.
